(19) United States
(12) Patent Application Publication
(10) Pub. No.: US 2022/0357173 A1
(43) Pub. Date: Nov. 10, 2022

(54) Method and Device for Customized Navigation

(71) Applicant: Telefonaktiebolaget LM Ericsson (publ), Stockholm (SE)

(72) Inventor: Ning Zhang, Beijing (CN)

(21) Appl. No.: 17/760,544

(22) PCT Filed: Sep. 19, 2019
(86) PCT No.: PCT/CN2019/106696

§ 371 Date: Mar. 15, 2022

(51) Int. Cl. G01C 21/36; G01C 21/34

(52) U.S. Cl. CPC G01C 21/3617; G01C 21/3484

(57) ABSTRACT

Various embodiments of the present disclosure provide a method performed by a terminal device. The method comprises obtaining information associated with a user of the terminal device (110) and determining at least one location candidate to be visited based on the information (120). The method further comprises providing one or more candidate navigation plans based on the at least one location candidate to the user of the terminal device (130). With this method, the data or information associated with a user can be efficiently utilized to provide a customized comprehensive guidance to the user when he/she is planning a tour for a target place to be visited.

### TECHNICAL FIELD

Embodiments of the present disclosure generally relate to the field of internet of things, and in particular, to a method and device for customized navigation.

### BACKGROUND

This section introduces aspects that may facilitate better understanding of the present disclosure. Accordingly, the statements of this section are to be read in this light and are not to be understood as admissions about what is in the prior art or what is not in the prior art.

An existing map or navigation software or application (APP), that may be installed on a personal terminal device, usually provides users with the almost same route guidance, as long as the places to be visited are the same or similar and the start and end points of the route are the same or similar, regardless of the users' age, gender, physical condition, psychological condition or environment situation etc. The existing map or navigation software/APP usually only has one version that is not matched to a specific group. For example, young and energetic people may like mountain climbing, while old people may enjoy cultural attractions and kids may like entertainment parks. However, the existing map or navigation software/APP cannot differentiate the age of users and may recommend to the users of different ages the same navigation route. That may, on one hand, lead to some places, e.g. scenic spots, being over crowed while others almost empty and on the other hand, the recommended places cannot meet different users' requirements and expectations.

Furthermore, the existing map or navigation software/APP doesn't provide any specified route for travelling around a scenic spot based on a user's physical and mental status. For example, some people may be worn out to visit a scenic spot by taking a recommended route, which however is too easy for other people. So, if the travel route cannot be comprehensively planned and places to be visited cannot be carefully recommended, it will cause frustration for users and leave them a bad impression on the recommended places.

On the other hand, the currently existing personal terminal devices, e.g. smart phones or wearable device, are always equipped with gigabytes of storage which stores all kinds of photos, videos, audios and texts associated with users of the devices. Some more information associated with the users may also be stored in Cloud. However, many of these data or information are in a “sleep” mode, that means they are seldomly used in addition to being occasionally viewed or browsed. This is somehow a waste of the storage resource.

### SUMMARY

In order to solve at least part of the above problems, various embodiments of the present disclosure propose to efficiently utilize the data or information associated with a user by e.g. analyzing the contents, properties and/ or attributes of the user's pictures, videos, audios and texts etc., and then combining them with e.g. the user's social network posts, blog articles or even Internet browsing caches etc., to provide a customized comprehensive guidance to the user when he/she is planning a tour to a target place to be visited.

In a first aspect of the present disclosure, there is provided a method performed by a terminal device. The method comprises obtaining information associated with a user of the terminal device and determining at least one location candidate to be visited based on the information. The method further comprises providing one or more candidate navigation plans based on the at least one location candidate to the user of the terminal device.

In an embodiment of the present disclosure, the information may be obtained from memory of the terminal device, from manual input to the terminal device, or from cloud.

In another embodiment of the present disclosure, the information may comprise any of: interests of the user; physical condition of the user; psychological condition of the user; a time schedule of the user; age of the user; and gender of the user.

In yet another embodiment of the present disclosure, the method may further comprise obtaining a current status of the user and obtaining environment information at a target location to be visited. In such embodiment, the at least one location candidate may be determined based further on the current status and the environment information.

In a further embodiment of the present disclosure, the environment information may comprise any of: weather condition; road condition; facilities along a route to be navigated; traffic condition; and population condition.

In yet another embodiment of the present disclosure, the method may further comprises sharing a selected navigation plan of the candidate navigation plan. The selected navigation plan may have been selected or additionally adjusted by the user of the terminal device.

In yet another embodiment of the present disclosure, the method may further comprise obtaining an access grant from the user of the terminal device to collect the information.

In a further embodiment of the present disclosure, the terminal device may be a smartphone, portable computer or a wearable device.

In a second aspect of the present disclosure, there is provided a terminal device according to embodiments of the present disclosure. The terminal device comprises a navigation unit, a processor, and a memory. The memory contains instructions executable by the processor whereby the terminal device is operative to perform the method according to any embodiment in the first aspect.

In a third aspect of the present disclosure, there is provided a computer program product being tangibly stored on a computer readable storage medium. The computer program product includes instructions which, when executed on at least one processor, cause the at least one processor to perform the method according to any embodiment in the first aspect.

It is to be understood that the summary section is not intended to identify key or essential features of embodiments of the present disclosure, nor is it intended to be used to limit the scope of the present disclosure. Other features of the present disclosure will become comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a flowchart of method 100 performed by a terminal device according to an embodiment of the present disclosure;

FIG. 2 shows an example where the method 100 according to embodiments of the present disclosure can be implemented;

FIG. 3 illustrates another example where the method 100 according to embodiments of the present disclosure can be implemented; and

FIG. 4 is a block diagram of a terminal device 400 according to embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities to build up a connection to the network. Examples of the terminal device include, but not limited to, IoT devices including wearable devices, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. The terminal device may also include vehicles in V2x communications via D2D sidelink, or cellular uplink.

As used herein, the singular forms “a”, “an” and “the” are intended to include the plural forms as well, unless the context clearly indicates otherwise. The term “includes” or “comprises” and its variants are to be read as open terms that mean “includes/ comprises, but not limited to.” The term “based on” is to be read as “based at least in part on.” The term “one embodiment” and “an embodiment” are to be read as “at least one embodiment.”

The term “another embodiment” is to be read as “at least one other embodiment.” Other definitions, explicit and implicit, may be included below.

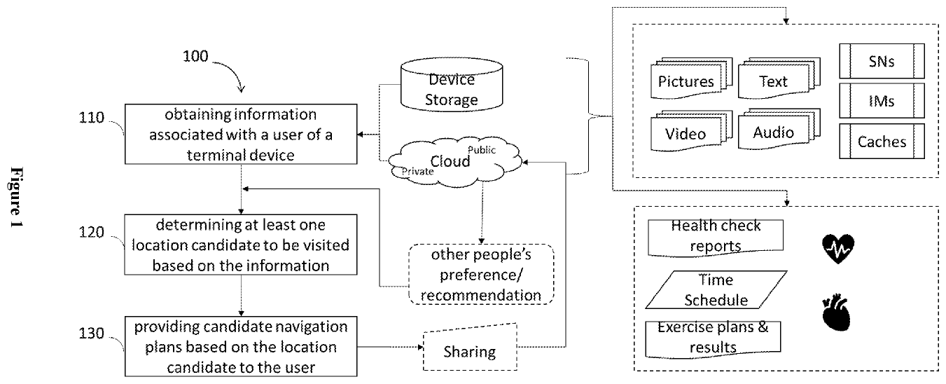

FIG. 1 illustrates a flowchart of method 100 performed by a terminal device according to an embodiment of the present disclosure.

As illustrated, the terminal device, e.g. a smart watch or a wearable device, obtains information associated with a user of the terminal device at block 110 and then determines at least one location candidate to be visited based on the information at block 120. Based on the at least one location candidate, the terminal device can provide one or more candidate navigation plans to the user of the terminal device at block 130.

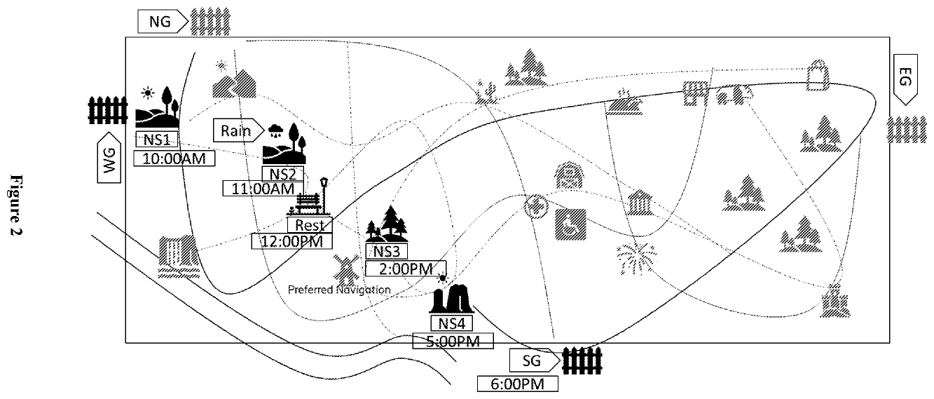

In an example, the method 100 may be triggered by start of a navigation software/APP as installed on the terminal device. The one or more candidate navigation plans may be presented in a form of navigation routes as shown later in FIG. 2.

In some embodiments, the information may comprise any of: interests or hobbies of the user; physical condition of the user; psychological condition of the user; a time schedule of the user; age of the user; and gender of the user.

In some embodiments of the present disclosure, the terminal device may obtain an access grant from the user of the terminal device to obtain the information.

If the user of the terminal device has granted access to data of other software or APPs installed on the terminal device, the information may be obtained from memory or storage of the terminal device, for example by analyzing user's texts, pictures, videos, audios stored in the terminal device and/ or by analyzing instant messages (IMs), posts published on social networks (SNs), or data in Caches, e.g. recently listened music or watched videos. In particular, the user's physical condition may be obtained from some APPs related to health and exercise, e.g. Health APP, Fitbit APP etc., or from the user's health check reports, or exercise plans & results. The user's psychological condition may be obtained, e.g. from an appointment in time schedule of the user with a psychological doctor, chat history, network browsing history etc.

In another embodiment of the present disclosure, the information may be obtained from input of the user to the terminal device. For example, if the user would like to visit a place (which is called a target location), he/she may input a name of the place into the terminal device, e.g., particularly into a navigation APP. Or, the user may prepare a time schedule for a trip or a travel itinerary and store it in the local memory of the terminal device.

In another embodiment of the present disclosure, the information may be obtained from cloud. For example, the user's pictures, videos, audios, or other data like text, instant messages, posts etc. which may be stored in the cloud and can be retrieved by the user. The cloud may include public and private parts. For the data stored in the public cloud, the data can be retrieved without limitation. However, for the data stored in the private cloud, the data retrieval may need a grant from the owner of that data. In such case, to obtain information from the private cloud, the terminal device may need to get a grant first for access to the data to be retrieved.

In yet another embodiment of the present disclosure, the terminal device may obtain preferences or recommendations of other people who may have similar interests or have visited the same places. Then based further on these preferences or recommendations, the terminal device can make the determination.

In some embodiments of the present disclosure, the terminal device may obtain a current status of the user and also obtain environment information. In such embodiments, the at least one location candidate may be determined based further on the current status and the environment information. For example, the environment information may comprise any of: weather condition (e.g. storm, rain, snow); road condition of a route to be navigated (e.g. an asphalt road or an unsurfaced road, a road with or without steps, overall user experience on the road is boring or interesting, such as full of flowers, trees, birds, small animals); facilities along the route to be navigated (e.g. whether there are washrooms, medical care centers, or even free WiFi spots etc. along the road); traffic condition (e.g. light traffic or congested); and population condition at a target location to be visited. In particular, the population condition information may include, but not limited to, a population density, a gender ratio, an age distribution, a percentage of people who share the same interest or habit with the user of the terminal device, so that they could make friends more easily.

In some embodiments of the present disclosure, the terminal device may share a selected navigation plan of the candidate navigation plans. In such embodiments, the selected navigation plan may be selected or additionally adjusted by the user of the terminal device, e.g. according to the user's input or preferences/ recommendations of other people who may have the similar interests or have visited the same places. Furthermore, the terminal device may also share his/ her own interests, preferences or recommendations to other people, e.g. by uploading his/her own pictures, videos, texts etc. to social networks or cloud storage etc.

With the method according to the above embodiments of the present disclosure, the data or information associated with a user can be efficiently utilized to provide a customized comprehensive guidance to a user when he/she is planning a tour to a target place to be visited. The target place could be a scenic spot, a park, a village, a city or any place which needs a navigation to travel around.

FIG. 2 shows an example where the method 100 according to embodiments of the present disclosure can be implemented. FIG. 2 illustrates a scenario when a person or a user would like to visit a scenic spot that he/she has never been before and without any previous experience from others.

In this example, the user starts the map APP installed on his/her terminal device, e.g. a smart phone or a wearable device. Then the APP may check and analyze the data associated with the user, like the stored pictures, videos, audios, texts like health check reports, messages, posts on social networks, etc. to obtain such information as the user's age, gender, interests/ hobbies, physical condition, or even psychological condition, and current body status, e.g. heart rate, blood pressure, etc.

Based on the obtained information, one or more candidate locations, e.g. the user's preferred places to be visited can be determined. The candidate locations or preferred places to be visited may be matched to a specific group, e.g. natural sceneries and cultural attractions for older people, entertainment parks for young children, or shopping malls for women etc.

In addition, considering the user's time schedule (e.g. about 6 hours for the tour), and/or the user's carry-on food etc., which may be manually input or obtained directly from RFID (Radio Frequency Identification) attached to the food, one or more candidate navigation plans can be recommended by the map APP. As shown in FIG. 2, the preferred navigation for a scenic spot is an example of the candidate navigation plans, that includes the determined one or more candidate locations.

Along the “preferred navigation”, the preferred places to be visited are marked with the estimated time costs for user's reference.

By referring to the user's time schedule, it can be known that he/she has about 6 hours to visit this scenic spot. Assuming that it is 10:00 AM now, then a route is planned to start from west gate (WG) towards south gate (SG).

By reading the user's carry-on foods in the user's bag, which may be manually input or obtained directly from the RFID attached to the food, it can be known that the food is enough so there's no need to go to a restaurant for lunch.

By checking the user's physical condition from previous health check reports and the blood pressure and heart rate, which may be detected automatically and dynamically, it can be known that the user is in good health condition. Thus, the route is planned to contain many natural sceneries as shown in the map.

Furthermore, the user can adjust his/her plans by adding or removing some places or locations of interest in the recommended route.

In addition, by checking the weather broadcast, it can be known that there will be scattered raining around 11:00 AM-1:00 PM, so a place for rest is added to the route, where the user can arrive by 12:00 PM for lunch so as to avoid the rain.

During the navigation, it will prompt the user to be careful that old trees along the path might fall.

Furthermore, by checking the news RSS (Really Simple Syndication), knowing that the sunset will be at 5:00 PM, it is recommended that the user can arrive at location

NS4 that is the best place to take pictures of the sunset. Such information may be obtained from blogs of other visitors. Many blogs of these visitors show beautiful sunset pictures at the location NS4. Thus, the APP will recommend the user to enjoy the scenic at this place.

By calculating all path lengths and considering the user's step length, frequency as well as the terrain, the preferred navigation will also show the approximately time when the user arrives at a place in the recommended route. The user can easily plan and adjust his/her tour without a rush.

Based on the statistical data on this area, it can be avoided to guide too many people in the same route, which would help the scenic spot administration to adjust traffic.

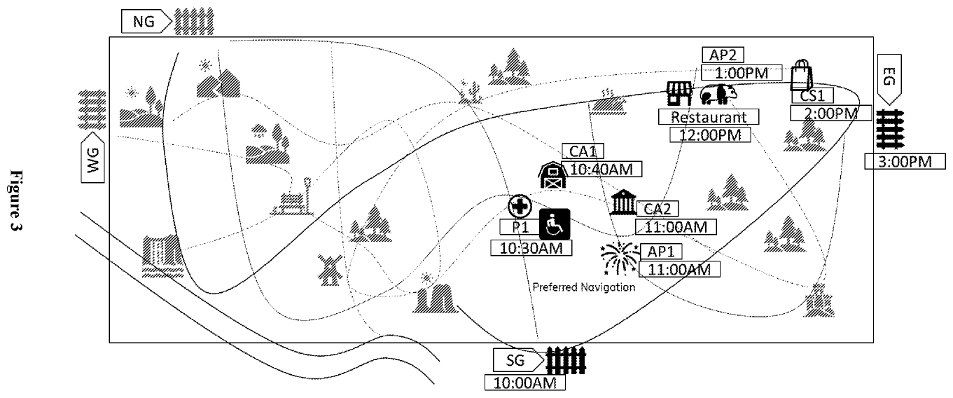

FIG. 3 illustrates another example where the method 100 according to embodiments of the present disclosure can be implemented. It is assumed that there is an elder man with his grandson to visit a scenic spot.

From the elder man's health check records, it can be known that the elder man should not have too much outdoor activities. From the elder man's previous pictures and/ or the news RSS or websites that he usually reads, it can be known that he likes cultural attractions. From his grandson's photos, it can be known that his grandson likes to play in entertainment parks. Also, the elder man is planning to buy some toys as a gift when leaving the scenic spot, like what most grandparents always do, based on big data analysis from the cloud.

Based on the above facts, a preferred navigation as shown in FIG. 3 is recommended. Along this navigation route, there is planned a medical care center (P1) for rest and in case the elder man feels uncomfortable, cultural attractions (CA1, CA2), a restaurant for rest and food, an entertainment park (AP2) for his grandson and a shopping street (CS1) for buying gifts along the route. It will take about 5 hours to complete the whole tour.

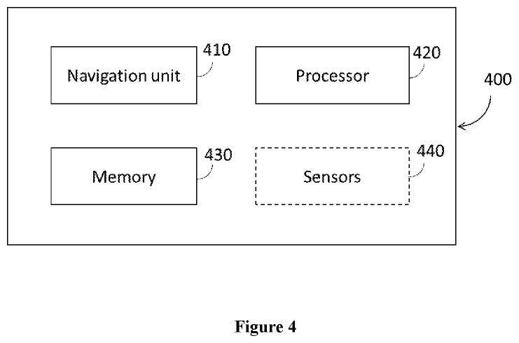

FIG. 4 is a block diagram of a terminal device 400 according to embodiments of the present disclosure.

As illustrated, the terminal device comprises a navigation unit 410, a processor 420, and a memory 430. The memory 430 contains instructions executable by the processor 420 whereby the terminal device is operative to perform the actions, e.g., of the method 100 as described in connection with FIG. 1.

For example, the terminal device can be a smart phone or a wearable device. Particularly, the memory 430 can contain instructions executable by the processor 420 whereby the terminal device 400 is operative to obtain information associated with a user of the terminal device, determine at least one location candidate to be visited based on the information; and provide one or more candidate navigation plans via the navigation unit based on the at least one location candidate to the user of the terminal device.

In some embodiments, the information may be obtained from the memory 430 of the terminal device, or from manual input of the user to the terminal device, or from cloud. In particular, the information may comprise any of: interests or hobbies of the user; physical condition of the user; mental state of the user; a time schedule of the user; age of the user; and gender of the user.

In some other embodiments, the terminal device may further comprise one or more sensors 440, such as GPS (Global Positioning System), a temperature sensor, an ambient light sensor, a proximity sensor, a gravity sensor, an accelerometer sensor, a magnetism sensor, a gyroscope etc.

In some other embodiments, the memory 430 may contain further instructions executable by the processor whereby the terminal device is operative to obtain a current status of the user via the one or more sensors and to obtain environment information via the one or more sensors. In such embodiments, the at least one location candidate may be determined based further on the current status and the environment information. The environment information may comprise any of: weather condition (e.g. storm, rain, snow); road condition (e.g. an asphalt road or an unsurfaced road, a road with or without steps, overall user experience on the road is boring or interesting, such as full of flowers, trees, birds, small animals); facilities along the route to be navigated (e.g. whether there are washrooms, medical care centers, or even free WiFi spots etc. along the road); traffic condition (e.g. light traffic or congested); and population condition at a target location to be visited. In particular, the population condition information may include, but not limited to, a population density, a gender ratio, an age distribution, a percentage of people who share the same interest or habit with the user of the terminal device, so that they could make friends.

In some other embodiments, the memory 430 may contain further instructions executable by the processor 420 whereby the terminal device is operative to share a selected navigation plan of the candidate navigation plans. The selected navigation plan was selected or additionally adjusted by the user of the terminal device.

The memory 430 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 430 is shown in the terminal device 400, there may be several physically distinct memory modules in the terminal device 400. The processor 420 may be of any type suitable to the local technical network, and may include one or more of general-purpose computers, special purpose computers, microprocessors, digital signal processors (DSPs) and processors based on multicore processor architecture, as non-limiting examples. The terminal device 400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides a computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 420 causes the terminal device to perform actions, e.g., of the procedure described earlier in conjunction with FIG. 1.

The computer program product may be configured as a computer program code structured in computer program modules. The computer program modules could essentially perform the actions of the flow illustrated in FIG. 1.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-17. (Canceled)

18. A method performed by a terminal device, comprising:
obtaining information associated with a user of the terminal device;
determining at least one location candidate to be visited based on the information; and
providing one or more candidate navigation plans based on the at least one location candidate to the user of the terminal device.

19. The method of claim 18, wherein the information is obtained from memory of the terminal device, from manual input to the terminal device, or from cloud.

20. The method of claim 18, wherein the information comprises any of:
interests of the user;
physical condition of the user;
psychological condition of the user;
a time schedule of the user;
age of the user; and
gender of the user.

21. The method of claim 18, further comprising:
obtaining a current status of the user; and
obtaining environment information;
wherein the at least one location candidate is determined based further on the current status and the environment information.

22. The method of claim 21, wherein the environment information comprises any of:
weather condition;
road condition;
facilities along a route to be navigated;
traffic condition; and
population condition at a target location to be visited.

23. The method of claim 18, further comprising:
sharing a selected navigation plan of the candidate navigation plans;
wherein the selected navigation plan was selected and adjusted by the user of the terminal device.

24. The method of claim 18, further comprising:
obtaining an access grant from the user of the terminal device to obtain the information.

25. The method of claim 18, wherein:
the terminal device is a smartphone, a portable computer or a wearable device.

26. A terminal device, comprising:
a navigation unit;
a processor; and a memory, the memory containing instructions executable by the processor whereby the terminal
device is operative to:
obtain information associated with a user of the terminal device;
determine at least one location candidate to be visited based on the information;
and
provide one or more candidate navigation plans via the navigation unit based on the at least one location candidate to the user of the terminal device.

27. The terminal device of claim 26, wherein the information is obtained from the memory of the terminal device, from manual input to the terminal device, or from cloud.

28. The terminal device of claim 26, wherein the information comprises any of:
interests of the user;
physical condition of the user;
psychological condition of the user;
a time schedule of the user;
age of the user; and
gender of the user.

29. The terminal device of claim 26, further comprising:
one or more sensors; and
wherein the memory contains further instructions executable by the processor whereby the terminal device is operative to:
obtain a current status of the user via the one or more sensors; and
obtain environment information via the one or more sensors;
wherein the at least one location candidate is determined based further on the current status and the environment information.

30. The terminal device of claim 29, wherein the environment information comprises any of:
weather condition;
road condition;
facilities along a route to be navigated;
traffic condition; and
population condition at a target location to be visited.

31. The terminal device of claim 26, wherein the memory contains further instructions executable by the processor whereby the terminal device is operative to:
share a selected navigation plan of the candidate navigation plans;
wherein the selected navigation plan was selected and adjusted by the user of the terminal device.

32. The terminal device of claim 26, wherein the memory contains further instructions executable by the processor whereby the terminal device is operative to:
obtain an access grant from the user of the terminal device to collect the information.

33. The terminal device of claim 26, wherein the terminal device is a smartphone, a portable computer, or a wearable device.
